(19) United States
(12) Patent Application Publication
(10) Pub. No.: US 2025/0373849 A1
(43) Pub. Date: Dec. 4, 2025

(54) SIGNALING PARAMETER SETS FOR GEOMETRY-BASED POINT CLOUD STREAMS

(71) Applicant: DRNC Holdings, Inc., Wilmington, DE (US)

(72) Inventors: Srinivas Gudumasu, Montreal (CA); Ahmed Hamza, Coquitlam (CA)

(73) Assignee: DRNC Holdings, Inc., Wilmington, DE (US)

(21) Appl. No.: 18/875,912

(22) PCT Filed: Jun. 27, 2023
(86) PCT No.: PCT/US2023/026346

§ 371 Date: Dec. 17, 2024

Related U.S. Application Data
(60) Provisional application No. 63/356,335, filed on Jun. 28, 2022.

(51) Int. Cl. H04N 19/597; H04N 19/132; H04N 19/70

(52) U.S. Cl. CPC H04N 19/597; H04N 19/132; H04N 19/70

(57) ABSTRACT

Systems, methods, and instrumentalities are disclosed for signaling parameter sets for geometry-based point cloud streams. In example, a device may receive an international organization for standardization base media file format (ISOBMFF) file. The ISOBMFF file may include geometry-based point cloud compression (G-PCC) data that is carried using one or more tracks with sample group description information and sample to group box information. The sample group description information may indicate grouping type information and a plurality of sample group description entries indicating geometry-based volumetric or point cloud parameter set information. The sample to group box information may include one or more sample to group box entries, each with a plurality of entry parameters comprising: the grouping type information, a grouping type parameter, and a sample group description index.

### CROSS-REFERENCE TO RELATED APPLICATION

This application claims the benefit of U.S. Provisional Patent Application No. 63/356,335, filed Jun. 28, 2022, the disclosure of which is incorporated herein by reference in its entirety.

### BACKGROUND

Video coding systems may be used to compress digital video signals, for example, to reduce the storage and/or transmission bandwidth needed for such signals. Video coding systems may include, for example, wavelet-based systems, object-based systems, and/or block-based systems, such as a block-based hybrid video coding system. Representation and/or compression mechanisms used for storing and/or transmitting of point cloud data may not be efficient.

### SUMMARY

Systems, methods, and instrumentalities are disclosed for signaling parameter sets for geometry-based point cloud streams.

An example device may receive an international organization for standardization base media file format (ISOBMFF) file. The ISOBMFF file may include geometry-based point cloud compression (G-PCC) data that is carried using one or more tracks with sample group description information and sample to group box information. The sample group description information may indicate grouping type information and a plurality of sample group description entries indicating geometry-based volumetric or point cloud parameter set information. The sample to group box information may include one or more sample to group box entries, each with a plurality of entry parameters comprising: the grouping type information, a grouping type parameter, and a sample group description index. The entry parameters may further comprise an entry count and/or a sample count.

In example, a device may receive an indication of geometry-based point cloud compression (G-PCC) samples and G-PCC information. The G-PCC samples may be associated with multiple tracks. The G-PCC information may include parameter set information and the parameter set information may include information associated with a set of samples. The device may determine, from a first time to a second time, that the parameter set information changes. Based on the parameter set information change, the device may group the G-PCC samples into each of the multiple tracks. The grouped G-PCC samples may include the same parameter set information.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example video encoder.

FIG. 3 is a diagram showing an example of a video decoder.

FIG. 4 is a diagram showing an example of a system in which various aspects and examples may be implemented.

FIG. 5 shows an example of a geometry-based point cloud compression (G-PCC) bitstream structure.

FIG. 6 shows an example of sample structure when coded G-PCC bitstream is stored in a single track.

FIG. 7 shows an example of multi-track G-PCC bitstream container structure.

FIG. 8 shows an example of G-PCC bitstream container structure with a G-PCC item and tile items.

FIG. 9 shows an example of a G-PCC bitstream container structure with a G-PCC item, tile items and spatial region item.

FIG. 10 shows an example of temporal levels in a G-PCC sequence.

FIG. 11 shows an example of using ‘gpsg’ sample group in multi-track and temporal level tracks.

FIG. 12 shows an example of using ‘gpsg’ sample group in multi component track.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

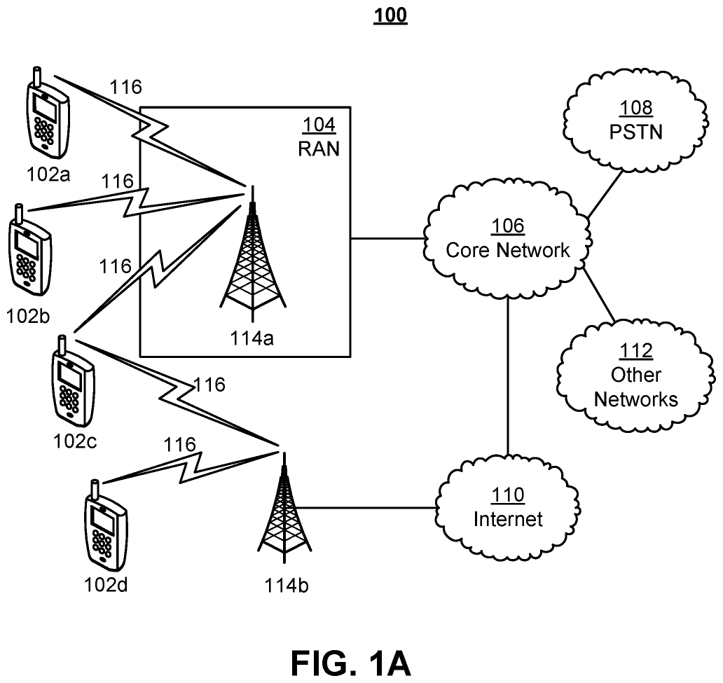

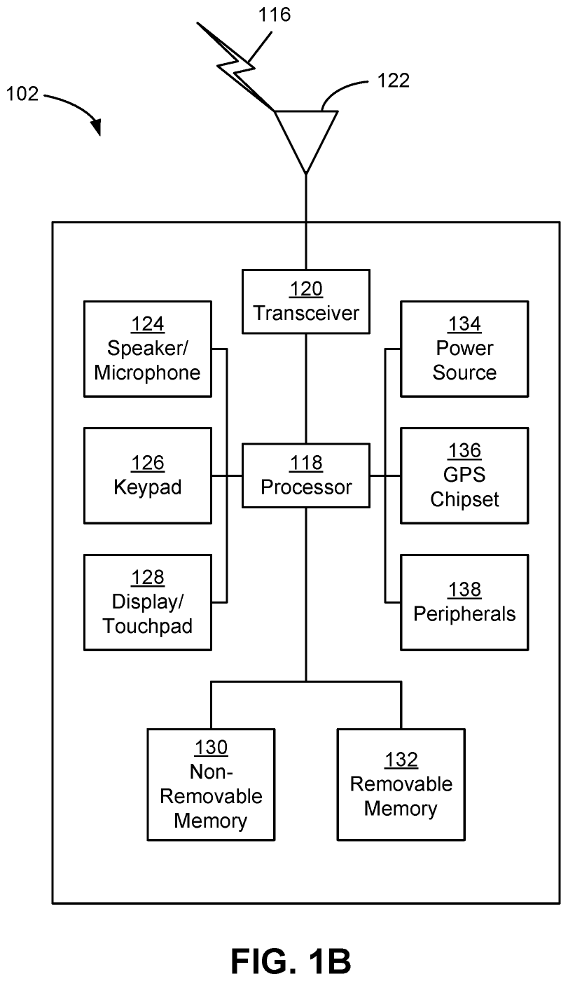

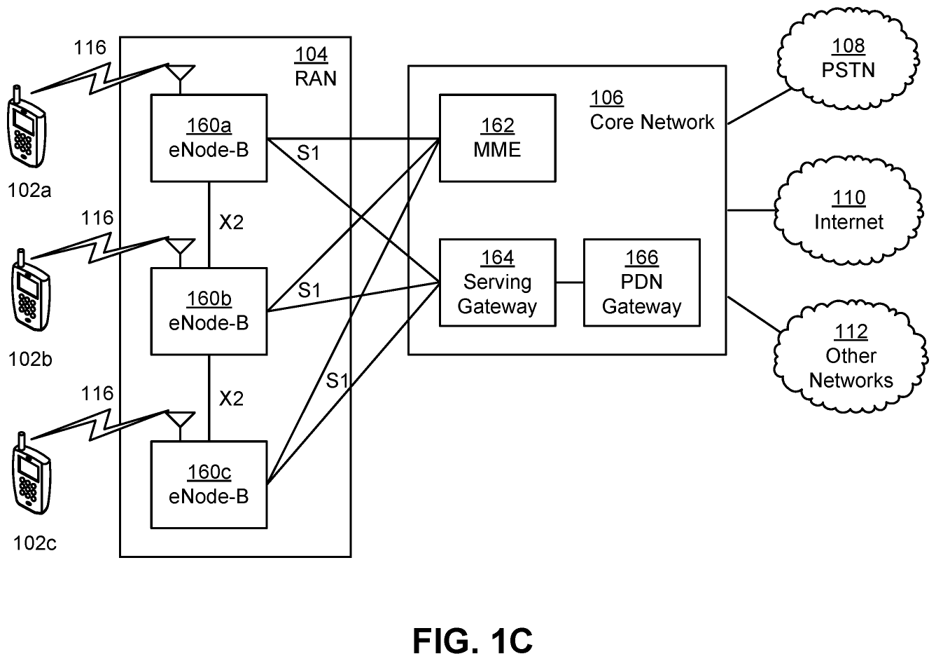

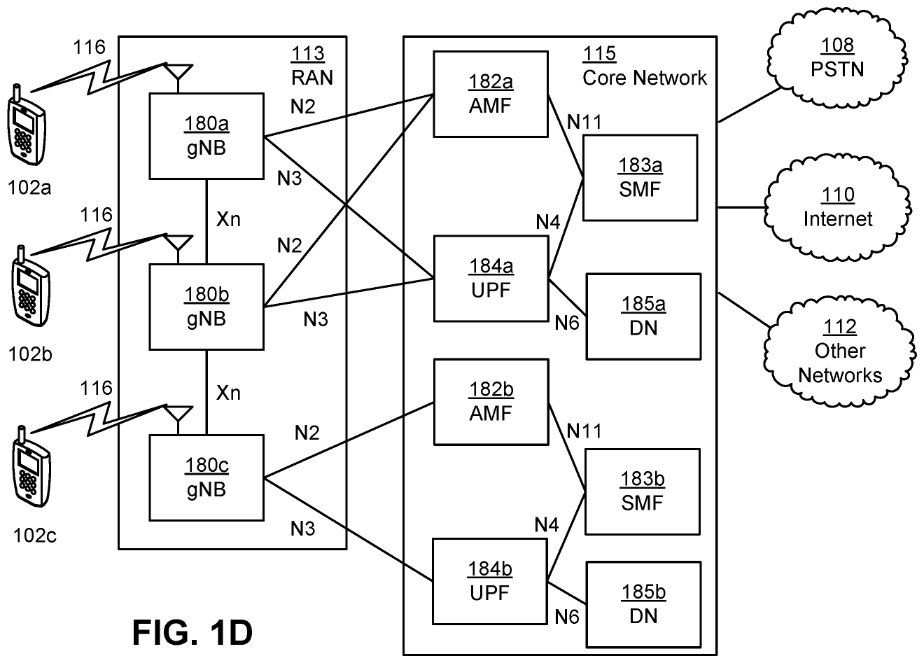

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WIFI), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 1020, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NIMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHZ channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b, and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

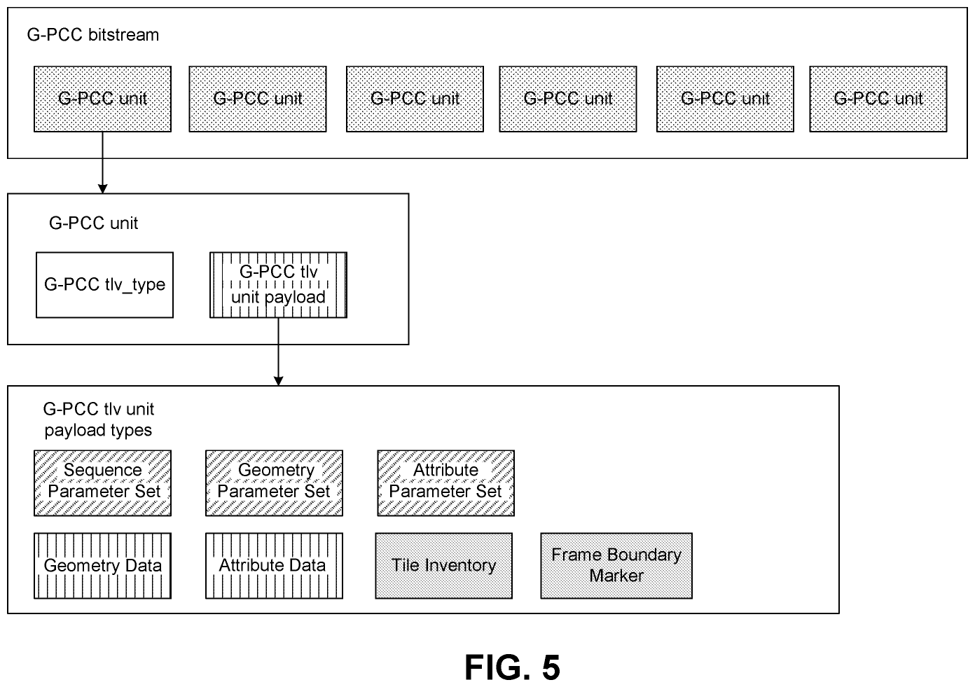

The aspects described and contemplated in this application may be implemented in many different forms. FIGS. 5-8 described herein may provide some embodiments, but other embodiments are contemplated. The discussion of FIGS. 5-8 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

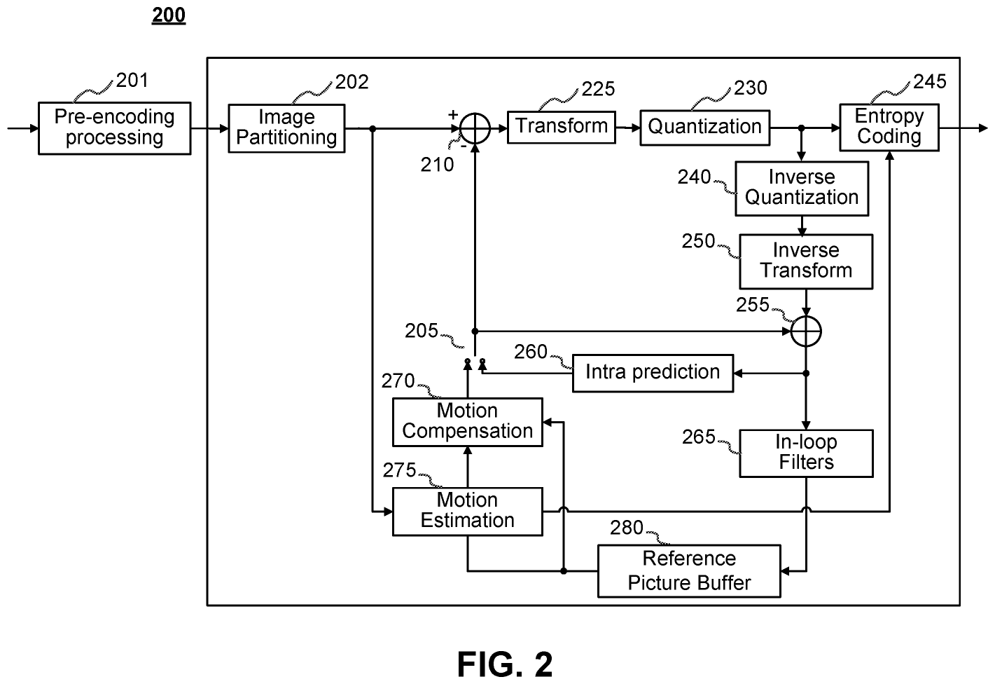

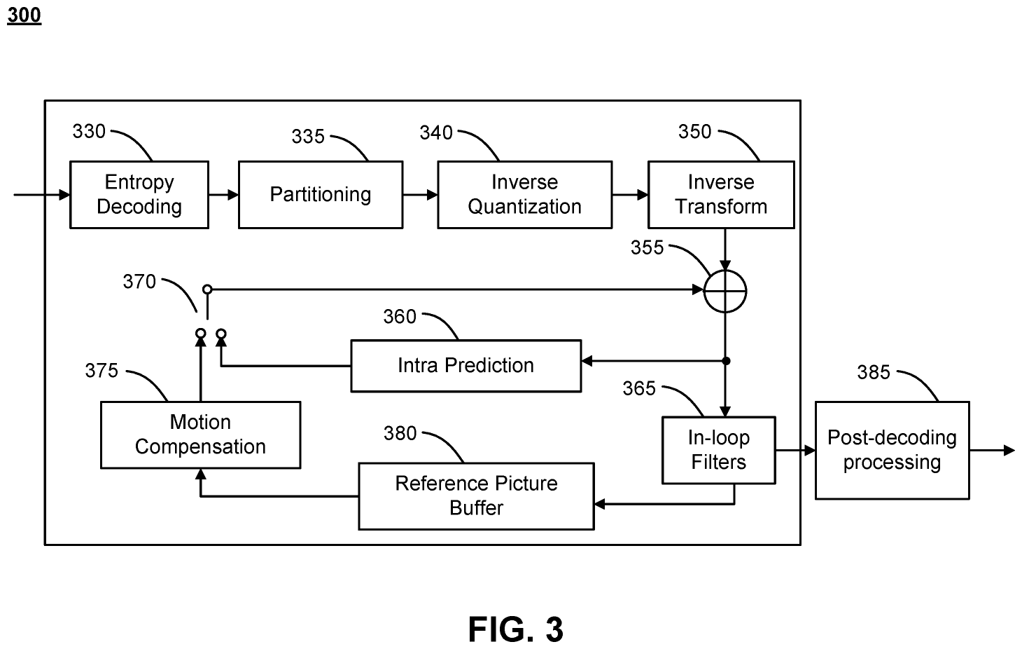

Various methods and other aspects described in this application may (for example, be used to) modify modules, for example, pre-encoding processing 201, intra prediction 260, entropy coding 245 and/or entropy decoding modules 330, intra prediction 360, post-decoding processing 385, of a video encoder 200 and a video decoder 300 as shown in FIG. 2 and FIG. 3 respectively. Moreover, the subject matter disclosed herein presents aspects that are not limited to WC or HEVC, and may be applied, for example, to any type, format or version of video coding, whether described in a standard or a recommendation, whether pre-existing or future-developed, and extensions of any such standards and recommendations (e.g., including WC and HEVC). Unless indicated otherwise, or technically precluded, the aspects described in this application may be used individually or in combination.

Various numeric values are used in examples described the present application, such as minimum and maximum value ranges (for example, 0 to 1, 0 to N or 0 to 255), bit values for indications or determinations, default values, ID numbers (for example, for adaptation IDs), etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 may also generally perform video decoding as part of encoding video data. For example, the encoder 200 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

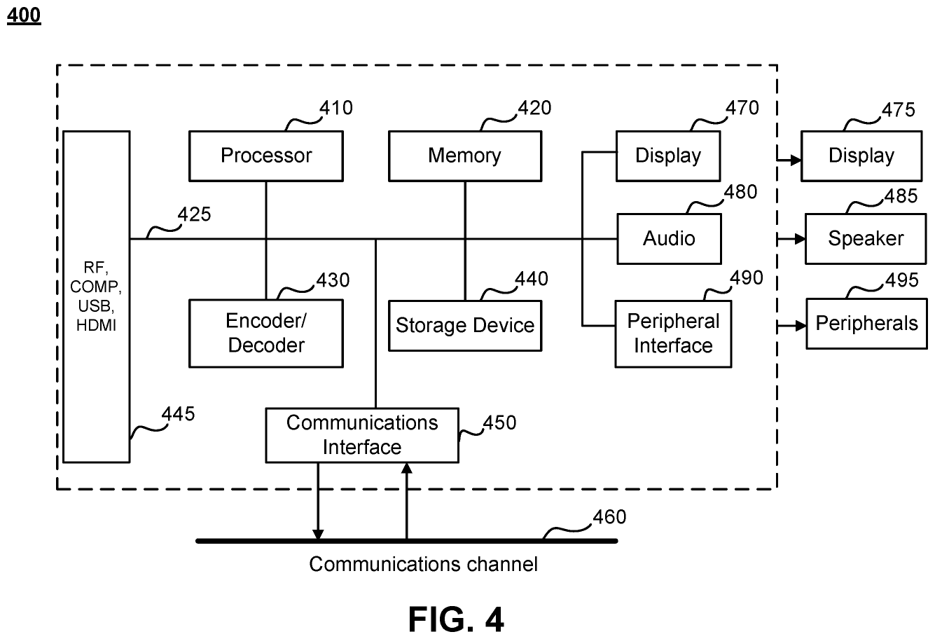

FIG. 4 is a diagram showing an example of a system in which various aspects and embodiments described herein may be implemented. System 400 may be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or WVC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which may be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and transmit data therebetween using suitable connection arrangement 425, for example, an internal bus as known in the art, including the Inter-IC (12C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, receiving an international organization for standardization base media file format (ISOBMFF) file. The ISOBMFF file may include geometry-based point cloud compression (G-PCC) data that is carried using one or more tracks with sample group description information and sample to group box information. The sample group description information may indicate grouping type information and a plurality of sample group description entries indicating geometry-based volumetric or point cloud parameter set information. The sample to group box information may include one or more sample to group box entries, each with a plurality of entry parameters comprising: the grouping type information, a grouping type parameter, and a sample group description index; etc.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, receiving an international organization for standardization base media file format (ISOBMFF) file. The ISOBMFF file may include geometry-based point cloud compression (G-PCC) data that is carried using one or more tracks with sample group description information and sample to group box information. The sample group description information may indicate grouping type information and a plurality of sample group description entries indicating geometry-based volumetric or point cloud parameter set information. The sample to group box information may include one or more sample to group box entries, each with a plurality of entry parameters comprising: the grouping type information, a grouping type parameter, and a sample group description index; etc.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, such as syntax elements that may be indicated in Tables 1-23 and otherwise indicated in discussion or figures presented herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

During the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some embodiments the encoder signals (e.g., to a decoder) an MPD, adaptation set, a representation, a preselection, G-PCC components, a G-PCCComponent descriptor, a G-PCC descriptor or an essential property descriptor, a supplemental property descriptor, a G-PCC tile inventory descriptor, G-PCC static spatial regions descriptor, GPCCTileld descriptor GPCC3DRegionID descriptor, among other descriptors, elements and attributes, metadata, schemas, etc. (for example, as disclosed herein, including in Tables 1-23), etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

High-quality three-dimensional (3D) point clouds may be utilized to represent immersive media. A point cloud may include a set of points represented in the 3D space using coordinates indicating the location of a point (e.g., each point) along with one or more attributes, such as the color associated with the point (e.g., each point), transparency, reflectance of laser or material property, etc. Point clouds may be captured in a number of ways. For example, point clouds may be captured using multiple cameras and depth sensors, light detection and ranging (LiDAR) laser scanners, etc. The number of points utilized to realistically reconstruct objects and scenes using point clouds may be in the order of millions (e.g., or even billions). Efficient representation and compression may be used for storing and transmitting point cloud data.

Technologies in capturing and rendering 3D points may have realized applications in the areas of tele-presence, virtual reality, and/or large-scale dynamic 3D maps. One or more of the following 3D point cloud compression (PCC) techniques may be used: a geometry-based compression standard for static point clouds and a video-based compression standard for dynamic point clouds. The techniques may be used to support efficient and interoperable storage and transmission of 3D point clouds. Based on the techniques, lossy and/or lossless coding of point cloud geometry coordinates and attributes may be supported.

FIG. 5 shows an example of a geometry-based point cloud compression (G-PCC) bitstream structure. Feature(s) associated with G-PCC are provided herein. As shown in FIG. 5, the structure of the bitstream for the geometry-based point cloud compression (G-PCC) may be demonstrated. The G-PCC bitstream may include a set of G-PCC units, which may be known as type-length-value (TLV) encapsulation structures, as shown in FIG. 5. The syntax of a G-PCC TLV unit may be given in Table 1, where a G-PCC TLV unit (e.g., each G-PCC TLV unit) has a TLV type (e.g., tlv_type), G-PCC TLV unit payload length (e.g., tlv_num_payload_bytes), and a G-PCC TLV unit payload (e.g., tlv_payload_byte[1]). The tlv_type may describe the G-PCC unit type as shown in Table 2. G-PCC TLV units with unit types 2 and 4 may be geometry and attribute data units, respectively. The data units may represent the main components for reconstructing the point cloud. The payload of geometry and attribute G-PCC units may correspond to media data units (e.g., TLV units) that may be decoded by the G-PCC decoder specified in the corresponding geometry and attribute parameter set G-PCC unit.

TABLE 1
G-PCC TLV unit syntax

| | Descriptor |
|---|---|
| tlv_encapsulation( ) { | |
| tlv_type | u(8) |
| tlv_num_ payload_bytes | u(32) |
| for( i = 0; i < tlv_num_payload_bytes; i++ ) | |
| tlv_payload_byte[ i ] | u(8) |
| } | |

TABLE 2
tlv_type and associated data unit description

| tlv_type | Description |
|---|---|
| 0 | Sequence parameter set |
| 1 | Geometry parameter set |
| 2 | Geometry data unit |
| 3 | Attribute parameter set |
| 4 | Attribute data unit |
| 5 | Tile inventory |
| 6 | Frame boundary marker |
| 7 | Defaulted attribute data unit |

TABLE 3
G-PCC attribute types by known_attribute_label

| known_attribute_label | Attribute type |
|---|---|
| 0 | Colour |
| 1 | Reflectance |
| 2 | Frame index |
| 3 | Material ID |
| 4 | Transparency |
| 5 | Normals |

TABLE 4
G-PCC TLV encapsulation unit payload syntax

Descriptor

```
tlv_payload( ) {
  if( tlv_type == GPCC_SPS )
    sequence_parameter_set( )
  else if( tlv_type == GPCC_GPS )
    geometry_parameter_set ( )
  else if(tlv_type == GPCC_APS )
    attribute_parameter_set ( )
  else if(tlv_type == GPCC_GD )
      geometry_data_unit ( ) {
        geometry_data_unit _header( )
        geometry_data_unit_data( )
          geometry_data_unit_footer( )
      }
    else if(tlv_type == GPCC_AD )
      attribute_data_unit_( ) {
        attribute_data_unit_header( )
        attribute_data_unit_data( )
      }
}
```

The G-PCC bitstream high-level syntax (HLS) may include slice and tile groups in geometry and attribute data. A frame may be partitioned into multiple files and slices. A slice may be a set of points that may be encoded or decoded independently. A slice may include one geometry data unit and zero or more attribute data units. Attribute data units may depend upon the corresponding geometry data unit within the same slice. Within a slice, the geometry data unit may appear before an associated attribute unit (e.g., any associated attribute units). The data units of a slice may be contiguous. The ordering of slices within a frame may be unspecified.

A group of slices may be identified by a common tile identifier. A tile inventory may describe a bounding box for a tile (e.g., each tile). A tile may overlap another tile in the bounding box. A slice (e.g., each slice) may include an index that identifies a tile to which the slice belongs.

Feature(s) associated with ISO base media file format (ISOBMFF) are provided herein. The ISOBMFF may include G-PCC data that is carried using one or more tracks. ISOBMFF may have multiple parts that may indicate file formats for the storage of time-based media. These parts may be based on and/or derived from the ISOBMFF, which may be a structural, media-independent definition. ISOBMFF may include structural and media data information for various presentation (e.g., timed presentations) of media data such as audio, video, etc. There may be support for un-timed data, such as meta-data at different levels within the file structure. The logical structure of the file may be a movie that may include a set of time-parallel tracks. The time structure of the file may be that the tracks include sequences of samples in time and those sequences are mapped into the timeline of the overall movie. ISO BMFF may be based on box-structured files. A box-structured file may include a series of boxes (e.g., which may be called atoms), which have a size and a type. The types may be 32-bit values and may be chosen to be four printable characters (e.g., known as a four-character code (4CC)). Un-timed data may be included in a metadata box, at the file level, or attached to the movie box or one of the streams of timed data, called tracks, within the movie.

Among the top-level boxes within an ISOBMFF container may be the MovieBox (‘moov’). MovieBox may include metadata for the continuous media streams present in the file. The metadata may be signaled within the hierarchy of boxes in the MovieBox (e.g., within the TrackBox (‘trak’). A track may represent a continuous media stream that is present in the file. The media stream may include a sequence of samples, such as audio or video units of an elementary media stream and may be enclosed within a MediaDataBox (‘mdat’) that is present at the top-level of the container. The metadata for a track (e.g., each track) may include a list of sample description entries, an entry (e.g., each entry) providing the coding or encapsulation format used in the track and the initialization data for processing samples in that track. A sample (e.g., each sample) may be associated with a sample description entry of the track. A tool may define an explicit timeline map for a track (e.g., each track). This may be known as an edit list and may be signalled using an EditList Box with the following syntax, where an entry (e.g., each entry) defines part of the track timeline by mapping part of the composition timeline or by indicating empty time (e.g., portions of the presentation timeline that map to no media, which may be referred to as an empty edit).

```
aligned(8) class EditListBox extends FullBox(‘elst’, version, flags) {
  unsigned int(32) entry_count;
  for (i=1; i <= entry_count; i++) {
    if (version==1) {
      unsigned int(64) edit_duration;
      int(64) media_time;
    } else { // version==0
      unsigned int(32) edit_duration;
      int(32) media_time;
    }
    int(16) media_rate_integer;
    int(16) media_rate_fraction = 0;
  }
}
```

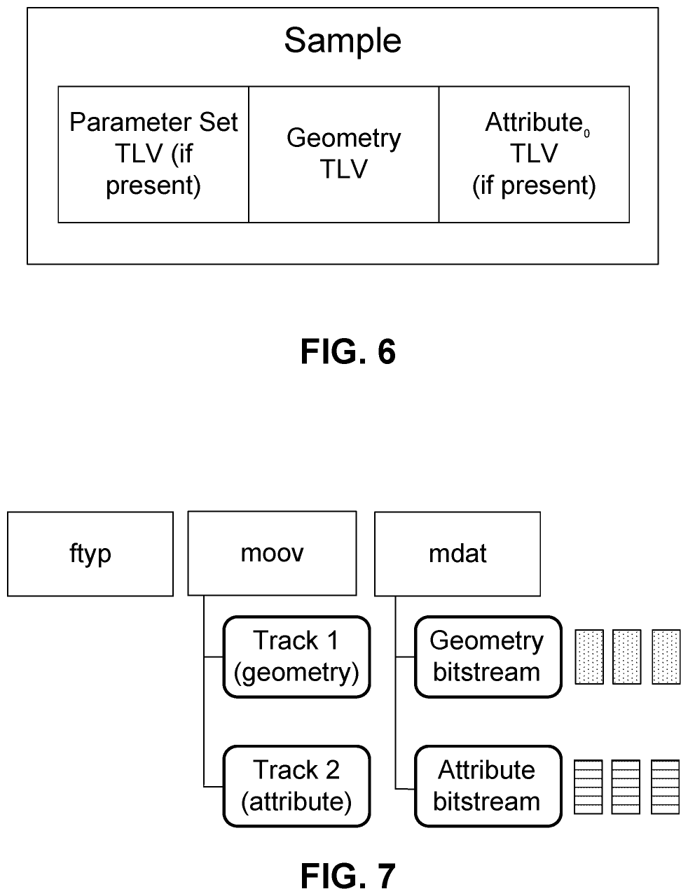

FIG. 6 shows an example of sample structure when coded G-PCC bitstream is stored in a single track. Feature(s) associated with a G-PCC container file format are provided herein. If the G-PCC bitstream is carried in a single track, the G-PCC encoded bitstream may be represented by a single-track declaration. Single-track encapsulation of G-PCC data may utilize the simple ISOBMFF encapsulation by storing the G-PCC bitstream in a single track (e.g., without further processing). A sample (e.g., each sample) in this track may include one or more G-PCC components. A sample (e.g., each sample) may include one or more TLV encapsulation structures. As shown in FIG. 6, the sample structure may be shown when the G-PCC geometry and attribute bitstream are stored in a single track.

FIG. 7 shows an example of multi-track G-PCC bitstream container structure. If the coded G-PCC geometry bitstream and the coded G-PCC attribute bitstream(s) are stored in separate tracks, a sample (e.g., each sample) in a track may include at least one TLV encapsulation structure carrying a single G-PCC component data. FIG. 7 shows the structure of a multi-track G-PCC container. The boxes may map to corresponding boxes.

Based on this structure, a multi-track G-PCC ISOBMFF container may include one or more of the following: a G-PCC track which includes a geometry parameter set, sequence parameter set and geometry bitstream samples carrying geometry data TLV units (e.g., this track may include track references to other tracks carrying the payloads of G-PCC attribute component(s) or zero or more G-PCC tracks, a track (e.g., track) including the respective attribute's attribute parameter set and attribute bitstream samples carrying attribute data TLV units.

If G-PCC bitstream is carried in multiple tracks, a track reference tool may be used to link between G-PCC component tracks. One TrackReference TypeBoxes may be added to a TrackReferenceBox within the TrackBox of the G-PCC track. The TrackReference TypeBox may include an array of track_IDs designating the tracks which the G-PCC track references. To link the G-PCC geometry track to the G-PCC attribute track, reference_type of a TrackReferenceTypeBox in the G-PCC geometry track may identify the associated attribute tracks. The 4CCs of these track reference types may be ‘gpca’ which may indicate that the referenced track(s) include the coded bitstream of a G-PCC attribute component.

If the 3D spatial region information and the associated G-PCC tiles within a 3D spatial region in the G-PCC bitstream are changing dynamically, a timed metadata track may carry the dynamically changing 3D spatial regions information. This 3D spatial regions information timed meta data track may provide the association between the 3D spatial region information and the corresponding G-PCC tiles for a 3D spatial region (e.g., each 3D spatial region) over time.

The timed-metadata track may include a ‘cdsc’ track reference to the G-PCC base track. The G-PCC base track may include a track reference type defined using the 4CC ‘gbsr’ to the timed-metadata track.

Non-timed G-PCC data may be encapsulated into an ISOBMFF file using items. An item may be a box carrying the data which does not use timed processing, as opposed to sample data.

The carriage of non-timed G-PCC data may be supported using a single item or multiple items with G-PCC tiles. For multiple items with G-PCC tiles, an item of type ‘gpt1’ along with a property item and item reference may be described herein to support the partial access.

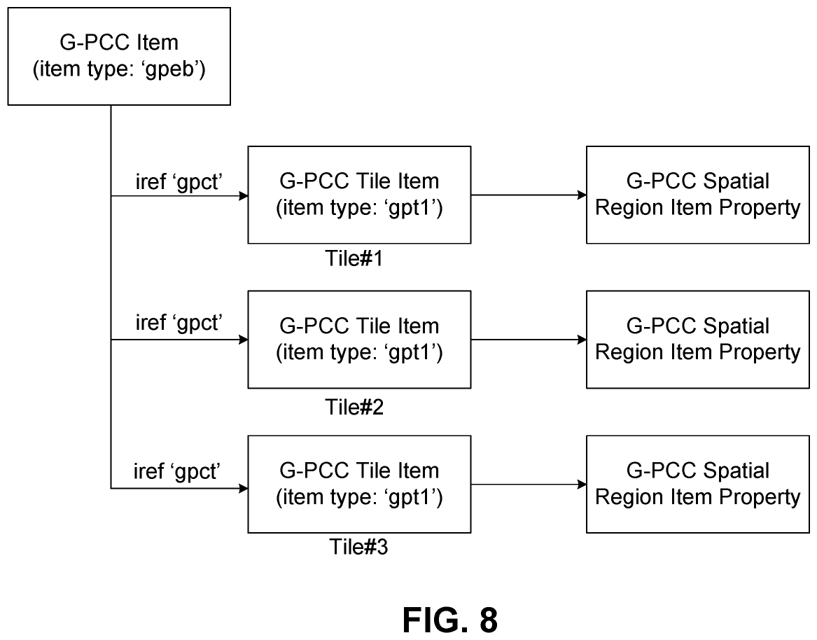

FIG. 8 shows an example of G-PCC bitstream container structure with a G-PCC item and tile items. As shown in FIG. 8, non-timed G-PCC data, including three G-PCC tiles, may be carried into multiple items by storing a G-PCC tile (e.g., each G-PCC tile) in separate items. This may enable a decoding device (e.g., a player) to identify an item that includes a proper G-PCC tile by interpreting the associated spatial region item property.

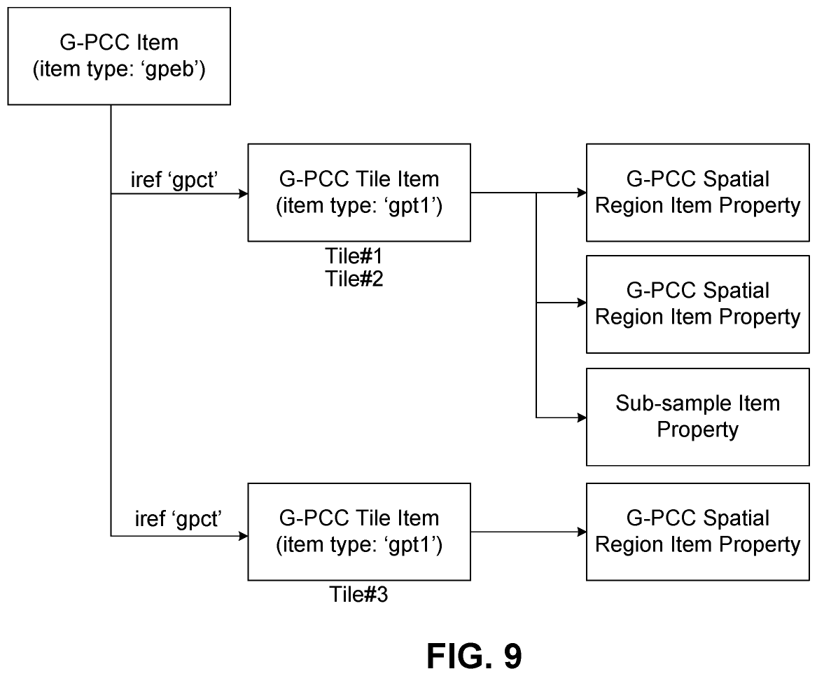

FIG. 9 shows an example of a G-PCC bitstream container structure with a G-PCC item, tile items, and a spatial region item. To support a finer-grain indication of G-PCC tiles, sub-sample information may be used (e.g., even though a G-PCC tile item may include multiple G-PCC tiles as described with respect to FIG. 9). For example, the sub-sample information may be suitable to indicate the identifier of tiles that are included within G-PCC tile item.

A G-PCC temporal level may be a subset of the frames in the G-PCC bitstream. The G-PCC temporal level may include a sub-sequence with a frame rate that is smaller than that of the actual bitstream sequence. A G-PCC frame (e.g., each G-PCC frame) may be associated with a temporal level (e.g., particular temporal level). A temporal level (e.g., each temporal level) may be identified by a temporal level identifier (e.g., unique temporal identifier) with the first temporal level having a temporal level identifier (ID) of 0.

A G-PCC bitstream (e.g., G-PCC data) may be carried and/or stored in one or more temporal level tracks. The G-PCC data may include a plurality of G-PCC samples. Information to describe the temporal level tracks and the mapping between samples and temporal level may be available in the file. A G-PCC sample belonging to a temporal level may not have decoding dependency (e.g., any decoding dependency) on G-PCC samples (e.g., any G-PCC samples) present in higher temporal levels. Prior to a coding (e.g., decoding) process, samples may be extracted from the temporal level track(s) and combined into a single conforming bitstream. When extracting a G-PCC bitstream for a target temporal level with an ID greater than 0 and target tile IDs, data from lower temporal levels samples (e.g., all lower temporal levels samples) may be included in the resulting bitstream and the tracks may be selected accordingly during the extraction process.

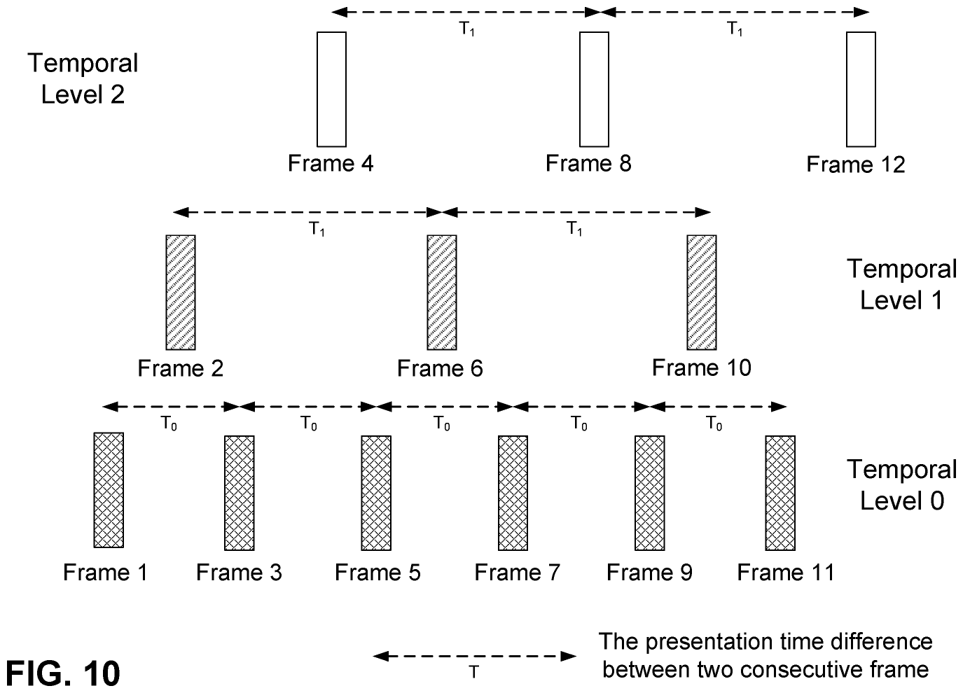

FIG. 10 shows an example of temporal levels in a G-PCC sequence. As shown in FIG. 10, the playback of a G-PCC bitstream at 30 fps, 45 fps, and 60 fps may be enabled if the G-PCC bitstream are divided into three temporal levels: temporal level 0 may represent a 30 fps subsequence, and temporal levels 1 and 2 may represent a 15 fps subsequence, respectively.

A G-PCC track including GPCCScalabilityInfoBox in the sample entry may be referred to as temporal level track carrying a subset of the bitstream. This box may signal scalability information for a G-PCC track. When this box is present in tracks with sample entries of type ‘gpe1’, ‘gpeg’, ‘gpc1’, ‘gpcg’, ‘gpcb’, and/or ‘gpeb’, it may indicate that temporal scalability is supported and provides information about the temporal levels present in that G-PCC tracks.

Feature(s) associated with media, such as VR and immersive 3D graphics, are provided herein. High-quality 3D point clouds may provide representation of immersive media, enabling forms of interaction and communication with virtual worlds. The large volume of information used to represent such point clouds may involve efficient coding algorithms. Example techniques for geometry-based compression of point clouds are described herein. Example techniques for temporal scalability are described herein. The temporal scalability may provide the temporal partial access support of a G-PCC data encapsulated in a container.

A point cloud sequence may represent a scene with multiple tiles. In examples, a coding device may be able to access (e.g., stream and/or render) individual tiles without having to decode other parts of the scene. Similarly, the point cloud may represent a single object. Certain parts of the object may be accessed (e.g., streamed and/or rendered) without decoding the entire point cloud.

Carriage of G-PCC data in a file may be supported using multiple temporal level tracks. A container (e.g., an ISOBMFF container) may signal the dynamically changing G-PCC parameter sets, including, for example, a geometry parameter set (GPS), a sequence parameter set (SPS), and/or an attribute parameter set (APS). A frame-specific attribute property (FSAP) parameter set may specify the attribute properties. The attribute properties may be utilized for a specific attribute frame. A coding device (e.g., encoder and/or decoder) may not know how to carry such parameter sets in the ISOBMFF when multiple tracks, multiple temporal level tracks, or multiple temporal level tile tracks are present.

As described herein, signaling techniques may be utilized to carry the dynamically changing G-PCC parameter sets in single-track, multi-track, G-PCC temporal level tracks, and temporal level tile tracks cases. The constraints on temporal level tracks and temporal level tile tracks sample entries may be updated as described herein.

Feature(s) associated with a G-PCC parameter sets sample group are provided herein. Feature(s) associated with a temporal level tracks case are provided herein. One or more tracks may be used to carry G-PCC data. A track (e.g., each of the one or more tracks) may include sample group description information (e.g., in a SampleGroupDescriptionBox) and sample to group box information (e.g., in a SampleToGroupBox). In examples, if the G-PCC data is carried using multiple temporal level tracks and the parameter set information is changing over time, the parameter sets information related to the samples present in that temporal level track may be signaled using the G-PCC parameter set information sample group with a grouping_type equal to ‘gpsg’. The grouping type may indicate that G-PCC samples that use the same sample group description entry (e.g., the same parameter set information) are grouped together. For example, the G-PCC parameter set information sample group with grouping type ‘gpsg’ may be used to group the G-PCC samples that use the same parameter sets information in a temporal level track. The use of ‘gpsg’ for the grouping type in sample group may represent the assignment of samples in a temporal level track to the corresponding parameter sets carried in this sample group. If a SampleToGroupBox with grouping_type equal to ‘gpsg’ is present, an accompanying SampleGroupDescriptionBox with the same grouping type may be present. SampleToGroupBox may include the index of the sample group description entry to which each sample belongs.

If a SampleToGroupBox with grouping_type equal to ‘gpsg’ is present, the SampleGroupDescriptionEntry at index 1 position of the associated SampleGroupDescriptionBox may carry the parameter sets used to decode the first sample in that temporal level track. The SampleGroupDescriptionBox at index 2 position and above may carry the changed parameter sets (e.g., only the changed parameter sets) associated with a sample or set of consecutive samples present in that temporal level track. In examples, a SampleGroupDescriptionEntry may carry setup units (e.g., only setup units) of one of the SPS, GPS, APS and FSAP parameter sets.

In examples, if the ‘gpc1’, ‘gpcg’, ‘gpe1’ or ‘gpeg’ sample entry is used in temporal level tracks, the sample group may include the G-PCC parameter sets used to decode the samples present in that temporal level track.

In examples, the SampleGroupDescriptionBox may not carry FSAP. FSAP may be carried in the samples of an attribute track.

Feature(s) associated with non-temporal level tracks (e.g., component tracks and single components tracks) are provided herein. If the G-PCC data is carried using a single G-PCC track or multiple G-PCC tracks and the parameter set information is changing over time, the parameter sets information related to the samples present in the G-PCC track(s) may be signaled using the G-PCC parameter set information sample group with a grouping_type ‘gpsg’. The G-PCC parameter set information sample group with grouping type ‘gpsg’ may be used to group the G-PCC samples that use the same parameter sets information in a G-PCC track. A SampleToGroupBox may include grouping type information (e.g., grouping_type). A SampleGroupDescriptionBox may include grouping type information (e.g., grouping_type). The use of ‘gpsg’ for the grouping_type in a sample group may represent the assignment of samples in a G-PCC track to the corresponding parameter sets carried in the sample group. The sample may include sample group description entries (e.g., one or more SampleGroupDescriptionEntry). The sample group description entries may indicate parameter set information (e.g., geometry-based or point cloud parameter set information). If a SampleToGroupBox with grouping_type equal to ‘gpsg’ is present, an accompanying SampleGroupDescriptionBox with the same grouping type may be present and may include the index of the group to which the samples belong. If a SampleToGroupBox with grouping type equal to ‘gpsg’ is present, the SampleGroupDescriptionEntry at index 1 position of the associated SampleGroupDescriptionBox may carry the parameter sets used to decode the first sample in that track. The SampleGroupDescriptionEntry at index 2 position and above may carry the updated parameter sets (e.g., only the update parameter sets) associated with a sample or set of consecutive samples present in that track.

In examples, a SampleGroupDescriptionEntry may carry setup units (e.g., only setup units) of one of the SPS, GPS, APS, and FSAP parameter sets.

If the ‘gpc1’, ‘gpcg’, ‘gpe1’ or ‘gpeg’ sample entry is used in G-PCC tracks and the sample group with a grouping_type ‘gpsg’ is present, the sample group may include the G-PCC parameter sets used to decode the samples present in that track.

A G-PCC temporal level track or a G-PCC track may include one or more SampleToGroupBox boxes with grouping_type equal to ‘gpsg’. If more than one SampleToGroupBox box with grouping_type equal to ‘gpsg’ exists, the SampleToGroupBox boxes may have unique grouping type parameter values and the version of each of the SampleToGroupBox boxes may be set to 1.

In examples, the SampleGroupDescriptionBox may not carry FSAP. FSAP may be carried in the samples of a specific attribute track.

Feature(s) associated with a components track case (e.g., normal and temporal level tracks cases) are provided herein. In examples, if the ‘gpe1’ or ‘gpeg’ sample entry is used in tracks, a G-PCC temporal level track or a G-PCC track may include multiple SampleToGroupBox boxes with grouping_type equal to ‘gpsg’ but with different grouping_type_parameter parameters. A sample group with a specific type of parameter set setup units may be identified using the ‘gpsg’ grouping_type and a unique grouping_type parameter value. If multiple SampleToGroupBox boxes are present with different grouping type parameter values, a SampleGroupDescriptionEntry (e.g., each SampleGroupDescriptionEntry) present in sample group description box with grouping type ‘gpsg’ may include one (e.g., only one) of SPS, GPS, APS, or frame-specific attribute parameters (e.g., but not a combination of parameter sets). For example, a SampleToGroupBox with grouping_type equal to ‘gpsg’ and grouping_type parameter value 1 may refer to the SampleGroupDescriptionEntry entries that include geometry parameter set setup units.

Similarly, a SampleToGroupBox with grouping_type parameter value 2 may refer to the SampleGroupDescriptionEntry entries that include attribute parameter set setup units, and a SampleToGroupBox with grouping type parameter value 3 may refer to the SampleGroupDescriptionEntry entries that include frame-specific attribute property parameter set setup units. The numOfSetupUnits present in a SampleGroupDescriptionEntry representing the setup units of one of SPS, GPS, or FSAP may be 1. The numOfSetupUnits present in a SampleGroupDescriptionEntry representing APS may be equal to the number of attributes present in the G-PCC bitstream or the updated APS sets of one or more attributes present in the bitstream.

A group type may be ‘gpsg’, which may be associated with a container sample group description box (e.g., ‘sgpd’). The group type ‘gpsg’ may not be used (e.g., may be associated with a quantity of zero). If the group type is ‘gpsg’ is used, and it may be associated with a quantity of one or more.

A G-PCC parameter set information sample group entry may define the parameter sets information for the samples that use the same G-PCC parameter sets. If multiple instances of SampleToGroupBox boxes with grouping_type equal to ‘gpsg’ are present, the version of the SampleToGroupBox boxes may be set to 1.

Example syntax for the G-PCC parameter sets sample group is provided below:

```
abstract class SampleGroupDescriptionEntry (unsigned int(32)
grouping_type)
{
}
abstract class VolumetricSampleGroupEntry (unsigned int(32)
grouping_type) extends SampleGroupDescriptionEntry
(grouping_type)
{
}
aligned(8) class GPCCParameterSetInfoEntry( )
extends VolumetricVisualSampleGroupEntry (‘gpsg’) {
  unsigned int(8) numOfSetupUnits;
  for (i=0; i < numOfSetupUnits; i++) {
    tlv_encapsulation setupUnit;
  }
}
```

Example semantics may include one or more of the following: numOfSetupUnits, or setupUnit. The parameter numOfSetupUnits may specify the number of G-PCC setup units signaled in the sample group description entry. The parameter setupUnit may include a G-PCC unit carrying one of an SPS, GPS, APS, or an FSAP parameter.

G-PCC parameter sets may not be carried in temporal level tile tracks. In examples, when the G-PCC data is carried using multiple temporal level tile tracks, the sample group with a grouping type ‘gpsg’ may not be present in tracks with sample entry ‘gpcb’, ‘gpeb’, or ‘gpt1’.

In examples, if the G-PCC data is carried using multiple temporal level tile tracks, samples in a G-PCC tile base track with a sample entry type of ‘gpcb’ or ‘gpeb’ may carry G-PCC units including one or more of the following: SPS, GPS, APS, tile inventory, or FSAP information.

The G-PCC tile base track sample used to decode the G-PCC temporal level tile track sample may be identified using the presentation time of the sample. The presentation time of the corresponding tile base track sample may be equal to or less than the presentation time of the temporal level tile track samples. If the presentation times of a tile base track sample and the corresponding temporal level tile track sample are not equal, the tile base track sample with a preceding presentation time closer to the presentation time of the temporal level tile track sample may be used for decoding the tile base track sample or identifying the tile inventory information.

The G-PCC tile base track sample with FSAP parameters information used to decode a G-PCC attribute temporal level tile track sample may be identified using the presentation time of the attribute G-PCC tile track sample. The presentation time of the corresponding tile base track sample with FSAP information may be same as the presentation time of the temporal level tile track sample carrying the attribute data.

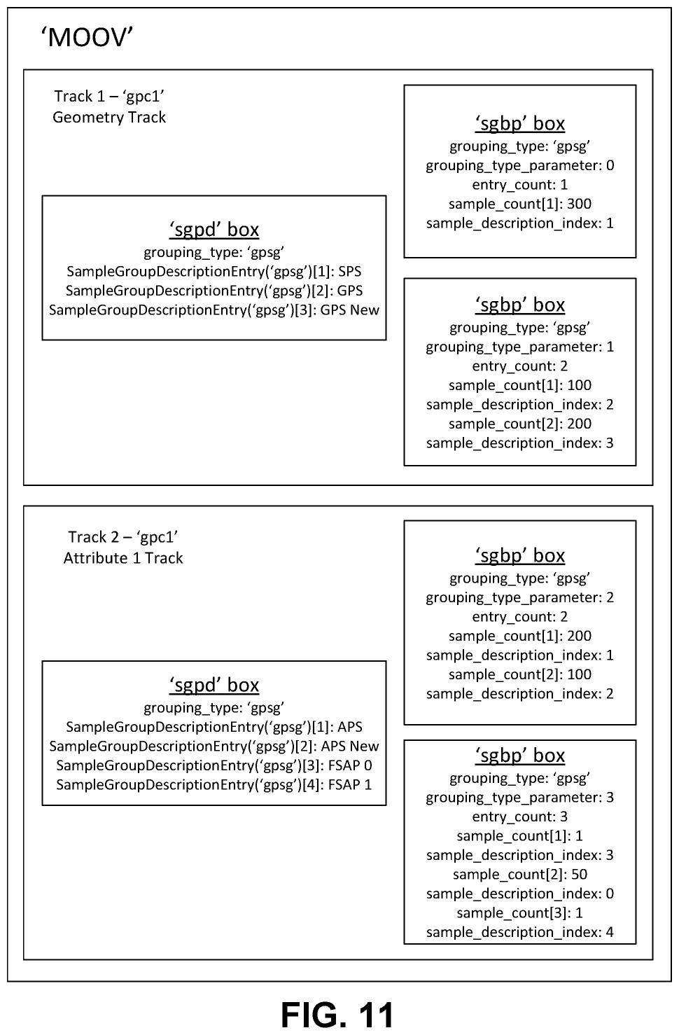

FIG. 11 shows an example of using a ‘gpsg’ sample group in multi-track and temporal level tracks. Feature(s) associated with an extraction process are provided herein. As shown in FIG. 11, a GPCC file structure may have two single component tracks. For a track, a sample group description box (e.g., an ‘sgpd’ box) and a sample to group box (e.g., one or more ‘sgbp’ boxes) with grouping type ‘gpsg’ may be present. Track 1 may be a geometry track (e.g., a geometry component track). Track 1 may include two sample to group boxes and a sample group description box with grouping_type equal to ‘gpsg’, including SPS and GPS parameter sets. Track 2 may be an attribute track. The sample to group box(es) may include sample to group box entries, which may include a plurality of parameters. For example, as illustrated in FIG. 11, the sample to group box entries may include the grouping type; a grouping type parameter (e.g., grouping_type_parameter); an entry count (e.g., entry_count); a sample count (e.g., sample_count); and/or a sample group description index (e.g., sample_description_index).

The grouping_type parameter may include a value that indicates parameter set setup units of the sample group description entries. For example, the sample to group box with grouping type parameter equal to 0 may include associated sample group description entries (e.g., SPS and GPS) including the setup units of an SPS parameter set. The sample to group box with grouping_type_parameter equal to 1 may include associated sample group description entries (e.g., SPS and GPS), including the setup units of GPS parameter sets. As another example, the sample to group box with grouping type parameter equal to 2 may include associated sample group description entries (e.g., APS and FSAP) including the setup units of an APS parameter set. The sample to group box with grouping type parameter equal to 3 may include associated sample group description entries (e.g., APS and FSAP), including the setup units of FSAP parameter sets.

If the GPS information changes over time, the GPS information (e.g., new GPS information) may be carried in a sample group description entry. The samples using the changed GPS parameter set may be indicated in the sample to group box with grouping_type parameter equal to 1. The sample_count may indicate how many samples are in a set of samples that use a particular parameter set. As shown in FIG. 11, samples from 1 to 100 (e.g., as indicated by sample_count [1] being set to 100) in track 1 may use GPS parameter set data from the sample group entry description at index 2, and the following 200 samples, samples 101 to 300 (e.g., as indicated by sample_count [2] being set to 200), may use the GPS parameter set data from the sample group entry description at index 3. The sample group entry description at index 2 and the sample group entry description at index 3 may be present in the sample group description box. Similarly, a sample to group box with grouping_type_parameter equal to 2 may indicate that samples from 1 to 200 (e.g., as indicated by sample_count [1] being set to 200) in track 2 use the APS parameter set data from sample group entry description at index 1, and the following 100 samples, samples 201 to 300 (e.g., as indicated by sample_count [2] being set to 100), use the APS parameter set data from sample group entry description at index 2.

The entry count may indicate a number of sets of samples. The sets of samples may each use a different sample group description entry. For example, as shown in the first sample to group box of FIG. 11, if the entry count is 1, there may be 1 set of samples that all use the same sample group description entry (e.g., in this case, the SPS indicated by sample_description_index 1). As another example, as shown in the second sample to group box of FIG. 11, if the entry count is 2, there may be 2 set of samples, where the samples of a set all use the same sample group description entry (e.g., in this case, the first 100 samples use GPS, as indicated by sample_description_index 2, and the following 200 samples use GPS New, as indicated by sample_description_index
3).

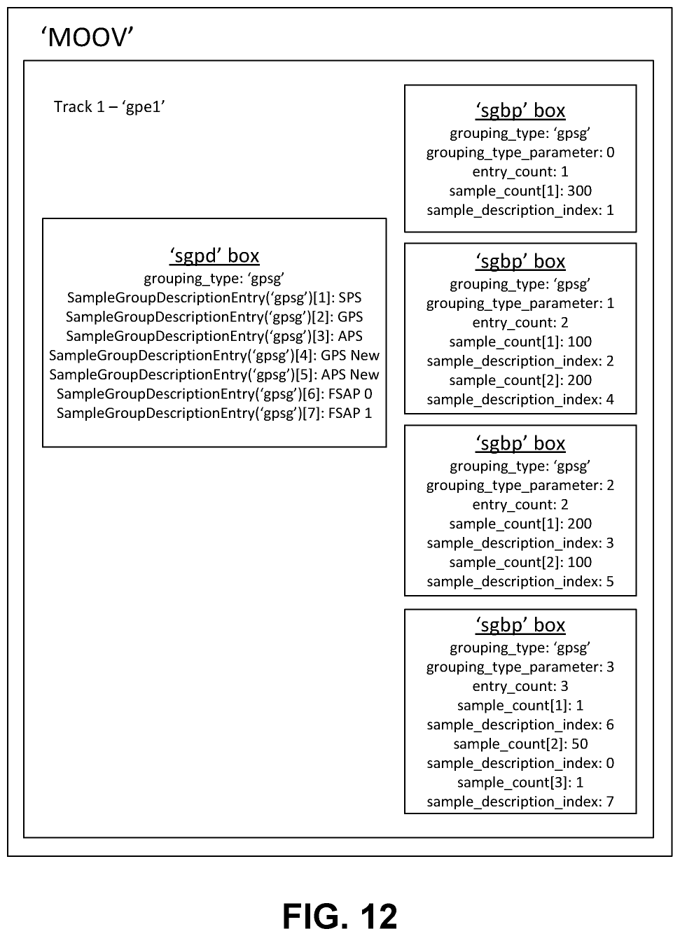

FIG. 12 shows an example of using a ‘gpsg’ sample group in a multi-component track. As shown in FIG. 12, a GPCC file structure may have a single multi-component track. The track may include a sample group description box and multiple instances of sample to group boxes with grouping type ‘gpsg’. As shown in FIG. 12, a first track (e.g., Track 1) may include four sample group boxes with grouping_type equal to ‘gpsg’ and with different grouping_type parameter values representing SPS, GPS, APS, and FSAP parameter sets. The entries of a sample to group box may be associated with a sample group description entry, including the setup units of one of SPS, GPS, APS, and FSAP parameter sets.

As shown in FIG. 12, the samples may use SPS present in SampleGroupDescriptionEntry at position 1. As indicated in SampleToGroupBox with grouping_type equal to ‘gpsg’ and grouping_type parameter value 1, samples from 1 to 100 may use GPS parameter set data from the sample group entry description at sample group description index 2, and samples 101 to 300 may use the GPS parameter set data from the sample group entry description at sample group description index 4 present in the sample group description box. As indicated in SampleToGroupBox with grouping_type equal to ‘gpsg’ and grouping_type_parameter value 2, samples from 1 to 200 may use the APS parameter set data from the sample group entry description at sample group description index 3, and samples 201 to 300 may use the APS parameter set data from the sample group entry description at sample group description index 5.

Example constraints on temporal level tracks and temporal level tile tracks are provided herein. A G-PCC track including GPCCScalabilityInfoBox in the sample entry may be referred to as a temporal level track carrying a subset of the bitstream. In examples, if the G-PCC data is carried using multiple temporal level tracks, the temporal level tracks carrying a G-PCC bitstream may use the same sample entry type. In examples, if the G-PCC data is carried using multiple temporal level tile tracks, the temporal level tile tracks carrying a G-PCC bitstream may use the same sample entry type ‘gpt1’.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method for signaling geometry-based volumetric or point cloud parameter set information, the method comprising:
receiving a file comprising geometry-based point cloud compression (G-PCC) data associated with a track, wherein the track comprises sample group description information and sample-to-group box information, wherein the sample group description information indicates grouping type information and a plurality of sample group description entries, wherein the plurality of sample group description entries comprise:
a first sample group description entry associated with a first sample group description index associated with a first parameter set type; and
a second sample group description entry associated with a second sample group description index associated with a second parameter set type; and
wherein the sample-to-group box information comprises:
a first sample-to-group box comprising a first grouping type parameter that indicates that a first set of samples use a first parameter set associated with the first sample group description index; and
a second sample-to-group box comprising a second grouping type parameter that indicates that a second set of samples use a second parameter set associated with the second sample group description index.

22. The method of claim 21, wherein the first sample-to-group box further comprises an entry count, wherein the entry count indicates a number of sets of samples in a plurality of sets of samples comprising the first set of samples, wherein each set of samples of the plurality of sets of samples is associated with a different sample group description entry of the plurality of sample group description entries.

23. The method of claim 21, wherein the plurality of sample group description entries further comprise a third sample group description entry associated with a third sample group description index associated with a third parameter set type, and wherein the sample-to-group box information further comprises a third sample-to-group box comprising a third grouping type parameter that indicates that a third set of samples use a third parameter set associated with the third sample group description index.

24. The method of claim 21, wherein the track is a first track, the sample group description information is first sample group description information, the sample-to-group box information is first sample-to-group box information, the plurality of sample group description entries is a first plurality of sample group description entries, the geometry-based volumetric or point cloud parameter set information is first geometry-based volumetric or point cloud parameter set information, and wherein the G-PCC data is further associated with a second track, wherein the second track comprises second sample group description information and second sample-to-group box information, wherein the second sample group description information indicates a second plurality of sample group description entries indicating second geometry-based volumetric or point cloud parameter set information, and wherein the second plurality of sample group description entries comprise:
a third sample group description entry associated with a third sample group description index associated with a third parameter set type; and
a fourth sample group description entry associated with a fourth sample group description index associated with a fourth parameter set type; and
wherein the second sample-to-group box information comprises:
a third sample-to-group box comprising a third grouping type parameter that indicates that a third set of samples use a third parameter set associated with the third sample group description index; and
a fourth sample-to-group box comprising a fourth grouping type parameter that indicates that a fourth set of samples use a fourth parameter set associated with the third sample group description index.

25. The method of claim 21, wherein the first parameter set is of the first parameter set type, the second parameter set is of the first parameter set type, and the first parameter set is a sequence parameter set, a geometry parameter set, an attribute parameter set, or a frame-specific attribute property parameter set.

26. The method of claim 21, wherein the grouping type information indicates that samples that use the same sample group description entry, of the plurality of sample group description entries, are grouped together.

27. The method of claim 21, wherein the first sample-to-group box further comprises a first sample count that indicates a number of samples in the first set of samples, and the second sample-to-group box further comprises a second sample count that indicates a number of samples in the second set of samples.

28. The method of claim 21, wherein the file is an ISO base media file format (ISOBMFF) file, and at least one sample in the second set of samples is in the first set of samples.

29. The method of claim 21, wherein the track is a geometry track, an attribute track, or a multi-component track.

30. The method of claim 21, wherein the track comprises one or more temporal level tracks.

31. A device for signaling geometry-based volumetric or point cloud parameter set information, the device comprising:
a processor configured to:
receive a file comprising geometry-based point cloud compression (G-PCC) data associated with a track, wherein the track comprises sample group description information and sample-to-group box information, wherein the sample group description information indicates grouping type information and a plurality of sample group description entries, wherein the plurality of sample group description entries comprise:
a first sample group description entry associated with a first sample group description index associated with a first parameter set type; and
a second sample group description entry associated with a second sample group description index associated with a second parameter set type; and
wherein the sample-to-group box information comprises:
a first sample-to-group box comprising a first grouping type parameter that indicates that a first set of samples use a first parameter set associated with the first sample group description index; and
a second sample-to-group box comprising a second grouping type parameter that indicates that a second set of samples use a second parameter set associated with the second sample group description index.

32. The device of claim 31, wherein the first sample-to-group box further comprises an entry count, wherein the entry count indicates a number of sets of samples in a plurality of sets of samples comprising the first set of samples, wherein each set of samples of the plurality of sets of samples is associated with a different sample group description entry of the plurality of sample group description entries.

33. The device of claim 31, wherein the plurality of sample group description entries further comprise a third sample group description entry associated with a third sample group description index associated with a third parameter set type, and wherein the sample-to-group box information further comprises a third sample-to-group box comprising a third grouping type parameter that indicates that a third set of samples use a third parameter set associated with the third sample group description index.

34. The device of claim 31, wherein the track is a first track, the sample group description information is first sample group description information, the sample-to-group box information is first sample-to-group box information, the plurality of sample group description entries is a first plurality of sample group description entries, the geometry-based volumetric or point cloud parameter set information is first geometry-based volumetric or point cloud parameter set information, and wherein the G-PCC data is further associated with a second track, wherein the second track comprises second sample group description information and second sample-to-group box information, wherein the second sample group description information indicates a second plurality of sample group description entries indicating second geometry-based volumetric or point cloud parameter set information, and wherein the second plurality of sample group description entries comprise:
a third sample group description entry associated with a third sample group description index associated with a third parameter set type; and
a fourth sample group description entry associated with a fourth sample group description index associated with a fourth parameter set type; and
wherein the second sample-to-group box information comprises:
a third sample-to-group box comprising a third grouping type parameter that indicates that a third set of samples use a third parameter set associated with the third sample group description index; and
a fourth sample-to-group box comprising a fourth grouping type parameter that indicates that a fourth set of samples use a fourth parameter set associated with the third sample group description index.

35. The device of claim 31, wherein the first parameter set is of the first parameter set type, the second parameter set is of the first parameter set type, and the first parameter set is a sequence parameter set, a geometry parameter set, an attribute parameter set, or a frame-specific attribute property parameter set.

36. The device of claim 31, wherein the grouping type information indicates that samples that use the same sample group description entry, of the plurality of sample group description entries, are grouped together.

37. The device of claim 31, wherein the first sample-to-group box further comprises a first sample count that indicates a number of samples in the first set of samples, and the second sample-to-group box further comprises a second sample count that indicates a number of samples in the second set of samples.

38. The device of claim 31, wherein the file is an ISO base media file format (ISOBMFF) file, and at least one sample in the second set of samples is in the first set of samples.

39. The device of claim 31, wherein the track is a geometry track, an attribute track, or a multi-component track.

40. The device of claim 31, wherein the track comprises one or more temporal level tracks.
